(19) United States
(12) Patent Application Publication
(10) Pub. No.: US 2026/0049527 A1
(43) Pub. Date: Feb. 19, 2026

(54) CONCEALED INTEGRATED SCREEN ASSEMBLY

(71) Applicant: SHANGHAI RILANG DOORS AND WINDOWS CO., LTD., Shanghai (CN)

(72) Inventors: Jingxuan YANG, Shanghai (CN); Qiaoling DUAN, Shanghai (CN)

(21) Appl. No.: 19/250,646

(22) Filed: Jun. 26, 2025

Related U.S. Application Data
(63) Continuation of application No. PCT/CN2023/102792, filed on Jun. 27, 2023.

(30) Foreign Application Priority Data
Jan. 6, 2023 (CN) 202320046245.2

(51) Int. Cl. E06B 9/52; E06B 3/36

(52) U.S. Cl. CPC E06B 9/521; E06B 3/36; E06B 2009/527

(57) ABSTRACT

A concealed integrated screen assembly includes a screen mesh, a window frame and a window sash rotatably connected to a sidewall of the window frame, where the window frame is hollow, a mounting housing is fixed on an inner wall of the window frame, a first side of the screen mesh is fixedly connected with an inner wall of the mounting housing, a second side of the screen mesh is fixed with a border assembly slidably connected to the window frame, a locking member for fixing the border assembly is provided on the window frame at a portion away from the mounting housing, and the sidewall of the window frame is provided with a restrictor assembly configured for restricting a rotation of the window sash.

### CROSS-REFERENCE TO RELATED APPLICATION

This application is a continuation of PCT application serial no. PCT/CN2023/102792, filed on Jun. 27, 2023, which claims the priority and benefit of Chinese patent application serial no. 202320046245.2, filed on Jan. 6, 2023. The entireties of PCT application serial no. PCT/CN2023/102792 and Chinese patent application serial no. 202320046245.2 are hereby incorporated by reference herein and made a part of this specification.

### TECHNICAL FIELD

The present application relates to the technical field of aluminum doors and windows, and, in particular, to a concealed integrated screen assembly.

### DESCRIPTION OF RELATED ART

With the improvement of people's living standards, aluminum alloy casement windows have been widely adopted. To prevent mosquitoes and other insects from entering the home through open windows during summer ventilation, it is standard practice to install recessed insect screens on windows.

The existing aluminum alloy window includes a window frame fixed to the interior wall of the window rough opening, with opening styles including swing, slide, and lift operation, etc. The screen track of this window is fixed to the facing surface of the window rough opening. When installing an external folding limit restrictor stay, it is mandatory to incorporate spacer plate to ensure opening or closing, failure to do so will cause mechanical interference with hardware components, or the screen must be fixed to the wall to increase separation from the hardware components. After the user removes the window screen, the window can be opened. Insects can be prevented from entering the home with the window screen.

The window screens discussed above, when deployed on the windows, are functionally compatible with sliding windows but cannot be applied to casement windows, indicating a clear requirement for design modification.

### SUMMARY

To facilitate screen installation on a casement window while maintaining coverage of the opening window by the screen mesh installed within the window rough opening, the present application provides a concealed integrated screen assembly.

The concealed integrated screen assembly includes a screen mesh, a window frame and a window sash rotatably connected to a sidewall of the window frame, where the window frame is hollow, a mounting housing is fixed on an inner wall of the window frame, a first side of the screen mesh is fixedly connected with an inner wall of the mounting housing, a second side of the screen mesh is fixed with a border assembly slidably connected to the window frame, a locking member for fixing the border assembly is provided on the window frame at a portion away from the mounting housing, and the sidewall of the window frame is provided with a restrictor assembly configured for restricting a rotation of the window sash.

By adopting the above technical solutions, the restrictor assembly restricts the rotation of the window sash, so as to reduce the possibility that the window sash can be easily opened by external forces. When the window sash is in a closed state, both the mounting housing and the border assembly are located on the inner wall of one side of the window frame, and the screen mesh cannot slide due to the obstruction of the window sash. After the window sash is opened, the user pulls the border assembly along the window frame, so that the border assembly slides to a position on the window frame away from the mounting housing. At this time, the locking member locks the border assembly, and the screen mesh shields the opening where the window sash is located in the closed state. The concealed installation method facilitates the installation of the screen mesh on the casement window, and the screen mesh shields the opening where window sash is located in the closed state.

Optionally, the inner wall of the window frame is fixed with a first thermal barrier, and the first thermal barrier is located between the window sash and a wall.

The first thermal barrier is made of nylon and configured to shield the inner cavity of the window frame, thereby reducing heat exchange between the interior and exterior of the house and playing a role in heat insulation.

Optionally, the locking member includes a magnetic block fixed on the inner wall of the window frame, and the portion of the window frame away from the mounting housing is made of a material magnetically attractable to the magnetic block.

By adopting the above technical solution, after the user opens the window sash, he pulls the border assembly to slide on the window frame, so that the border assembly is attracted to the inner wall of the window frame, which restricts the sliding of the border assembly on the window frame, to secure a stable mesh positioning of the screen mesh relative to the window.

Optionally, a snap-fit groove is formed on the sidewall of the window frame, a sidewall of the window sash is configured with a mounting keyway, the restrictor assembly includes a restrictor bracket detachably fixed on the sidewall of the window sash, an end of the restrictor bracket away from the snap-fit groove is fixedly hooked in the mounting keyway, the restrictor bracket is located at a position on the window sash away from a pivot axis of the window sash, and the restrictor bracket is snap-fitted into the snap-fit groove.

By adopting the above technical solution, the restrictor bracket is snap-fitted into the snap-fit groove. Rotating the window sash causes the restrictor bracket to be engaged with the mounting keyway, thereby restricting the rotation of the window sash. When the operator separates the restrictor bracket from the snap-fit groove, the restrictor bracket may be removed from the window frame.

Optionally, edges of the restrictor bracket are configured with rounded corners, and an opening of the snap-fit groove features an arc transition.

By adopting the above technical solution, guidance is provided for the snap-fit connection between the restrictor bracket and the snap-fit groove, thereby making it more convenient to realize the snap-fit connection between the restrictor bracket and the snap-fit groove.

Optionally, a waterproof sheet is fixed on a sidewall of the window sash, and the waterproof sheet is angled to the window frame.

By adopting the above technical solution, the waterproof sheet shields the installation area of the glass on the window sash, so as to prevent external moisture from migrating into the interior of the room through the installation area of the glass.

Optionally, the inner wall of the window frame is detachably connected with a second thermal barrier, and the second thermal barrier is located between the first thermal barrier and the window sash.

By adopting the above technical solution, when the screen mesh is not required, there is no need to install the concealed screen mesh. The second thermal barrier is configured to block the external cold air, thereby enhancing the sealing performance of the window. And when it is necessary to install the concealed screen mesh, the second thermal barrier can be removed to reduce interference to the installation of the screen mesh.

Optionally, a side of the border assembly away from the screen mesh is fixed with a pull tab, and the pull tab is angled to the screen mesh

By adopting the above technical solution, when the user pulls the pull tab in the direction away from the mounting housing, the border assembly is driven to slide on the window frame. The arrangement of the pull tab makes it convenient for users to drive the border assembly to slide.

Optionally, the window frame includes a main frame and a mounting bracket fixed on the main frame, an acoustic seal block is fixed on a sidewall of the mounting bracket, the mounting housing is fixedly connected with the acoustic seal block, the border assembly is slidable out from the main frame, a protective housing is fixed on the sidewall of the mounting bracket, and the acoustic seal block is located inside the protective housing.

By adopting the above technical solution, the mounting bracket has a relatively high strength, thereby enhancing the strength of the window frame. The acoustic seal block is made of rubber, to improve the sealing performance of the mounting bracket and thus the window frame. The protective housing shields the acoustic seal block and the mounting housing from external light exposure, thereby decelerating UV-induced degradation.

In conclusion, the present application includes at least one of the following beneficial technical effects:
1. When there is no need to use the screen mesh to shield the window, the mounting housing, the screen mesh, and the border assembly are all located on the inner wall of the window frame. The concealed installation of the screen mesh enhances the aesthetic appeal of the window. When the window sash is opened and the screen mesh is required to shield the window, the user pulls the border assembly to slide on the window frame, causing the border assembly to slide to a position on the window frame away from the mounting housing, and the locking member prevents the border assembly from sliding. At this moment, the screen mesh shields the opened window.
2. The first thermal barrier insulates the inner cavity of the border assembly, thereby reducing heat exchange between the interior and exterior of the house. In cold environments, the second thermal barrier is installed on the inner wall of the window frame, with the mounting housing and border assembly positioned between the first and second thermal barriers, thereby further enhancing the heat insulation performance of the window frame.

### BRIEF DESCRIPTION OF THE DRAWINGS

FIG. 1 is a schematic view of the overall structure of the concealed integrated screen assembly in the first embodiment of the present application, showing a closed state of the window sash.

FIG. 2 is a schematic view of the overall structure of the concealed integrated screen assembly in the first embodiment of the present application, showing an opening state of the window sash.

FIG. 3 is a cross-sectional view of the magnetic block in the first embodiment of the present application, showing the position of the magnetic block.

FIG. 4 is an enlarged view of part A of FIG. 1.

FIG. 5 is a schematic view of the overall structure of the concealed integrated screen assembly in the second embodiment of the present application.

### DESCRIPTION OF THE EMBODIMENTS

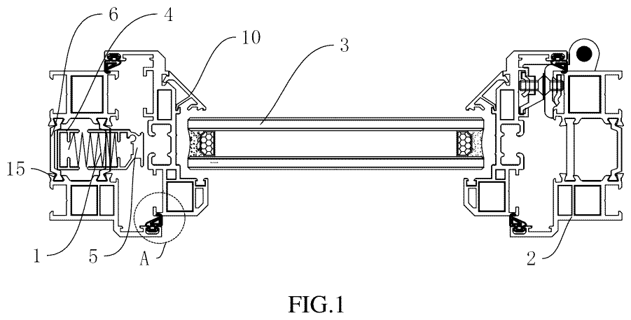

The present application will be described in further detail in combination with FIGS. 1-5.

Embodiments of the present application disclose a concealed integrated screen assembly.

The first embodiment.

Referring to FIG. 1, a concealed integrated screen assembly includes a window frame 2. The window frame 2 of the present application includes two frame bodies, one of which is hinged to a window sash 3 by means of a hinge at an outer wall of the frame body. During installation, the two frame bodies are fixed to the wall, forming a cavity between them. The side wall of each frame body is configured with two first retention grooves 15, four retention grooves 15 are provided in the present application. A first thermal barrier 6 is snap-fitted and fixed into the inner walls of the first retention grooves 15 on the two frame bodies. The first thermal barrier 6 is made of nylon and designed to block external air flow, so as to reduce the entry of external cold air into the room through the gap between the two frame bodies, thereby providing thermal break functionality.

Referring to FIG. 1, a mounting housing 4 is fixed between the two frame bodies. The mounting housing 4 is located on the part of the frame body away from the pivot axis of the window sash 3. A screen mesh 1 is fixed on the inner wall of the mounting housing 4. One side of the screen mesh 1 is fixedly connected to the inner wall of the mounting housing 4, and the side of the screen mesh 1 away from the mounting housing 4 is fixed with a border assembly 5. The border assembly 5 is slidably mounted between the two frame bodies. After the window sash 3 is opened, the border assembly 5 can be pulled to slide away from the mounting housing 4. At the moment, the screen mesh 1 serves to shield the window.

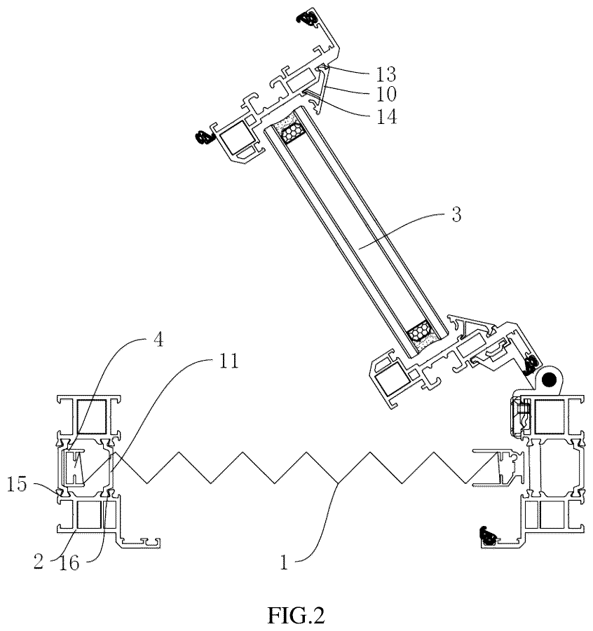

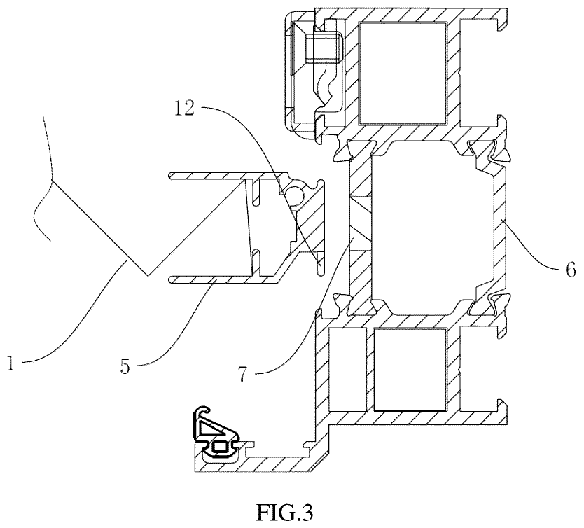

Referring to FIGS. 2-3, the inner wall of the window frame 2 is provided with a locking member configured for arrest the sliding of the border assembly 5. The locking member of the present embodiment includes a magnetic block 7 fixed on the sidewall of the frame body. A side of the border assembly 5 facing the magnetic block 7 is made of a metal material attracted by the magnetic block 7. After the border assembly 5 is pulled to slide so that the screen mesh 1 shields the window, the magnetic block 7 attracts the border assembly 5, to restrict the sliding of the border assembly 5, thereby ensuring stable mesh positioning of the screen mesh 1 relative to the window.

Referring to FIG. 3, a pull tab 12 is welded on the outer wall of the border assembly 5. The pull tab 12 of the present application is perpendicular to the sliding direction of the border assembly 5. A user places a finger on the pull tab 12 and pulls it away from the mounting housing 4 to slide the border assembly 5. It is convenient for the user to slide the border assembly 5 by means of the pull tab 12.

Referring to FIG. 2, the sidewall of the window sash 3 is configured with a first stop groove 13 and a second stop groove 14. A waterproof strip 10 is clamped and fixed within the first stop groove 13 and the second stop groove 14. The waterproof strip 10 forms an obtuse angle with the glass on the window sash 3. During rainy weather, rainwater slides along the outer surface of the waterproof strip 10. The risk that external moisture enters the interior space is reduces by the waterproof strip 10.

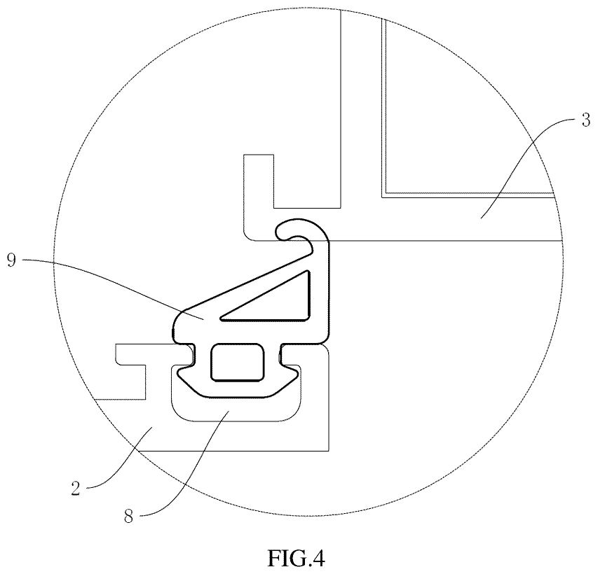

Referring to FIGS. 3-4, the sidewall of the border assembly 5 is provided with a restrictor assembly configured for restricting the rotation of the window sash 3. The sidewall of the border assembly 5 is configured with a snap-fit groove 8, with the edges of the snap-fit groove 8's opening rounded. A mounting keyway is formed in the sidewall of the window sash 3. The restrictor assembly includes a restrictor bracket 9 positively engaged with the window sash 3 via the mounting keyway. The edges of the restrictor bracket 9 facing the snap-fit groove 8 are rounded, facilitating the engagement of the restrictor bracket 9 with the snap-fit groove 8. After the user closes the window, he pulls the window sash 3 toward the interior of the snap-fit groove 8, so that the portion of the restrictor bracket 9 near the window sash 3 may be engaged with the mounting keyway, thereby positioning the window sash 3 and restricting the rotation of the window sash 3.

Referring to FIG. 2, the inner walls of both frame bodies are each provided with second retention grooves 16. Four second retention grooves 16 are provided in the present application. A second thermal barrier 11 is snap-fitted and fixed into two second retention grooves 16. The second thermal barrier 11 is positioned between the two frame bodies and on a side of the border assembly 5 away from the mounting housing 4. The second thermal barrier 11 of the present application is made of nylon. In cold environments, when the concealed screen mesh 1 is not required, the second thermal barrier 11 is fixed on the inner wall of the border assembly 5. The risk that external air enters the space between the two frame bodies is reduced by means of the second thermal barrier 11, thereby improving the thermal break effect of the window. When the concealed screen mesh 1 needs to be installed, the second thermal barrier 11 is removed to reduce interference to the installation of the screen mesh 1.

In the first embodiment of the present application, the working principle of the concealed integrated screen assembly is as follows. When the user pushes the window sash 3 outward to disengage the restrictor bracket 9 from the window sash 3, the window can be opened. The user then places his finger on the sidewall of the pull tab 12 and pulls it away from the mounting housing 4 to slide the border assembly 5. The screen mesh 1 is positioned to shield the opening where the window sash 3 was located under the attraction of the magnetic block 7, so as to prevent external insects from entering the house. When closing the window, the border assembly 5 is moved back between the two frame bodies, and the window sash 3 is pulled, until the restrictor bracket 9 is snap-fitted with the snap-fit groove 8.

The second embodiment.

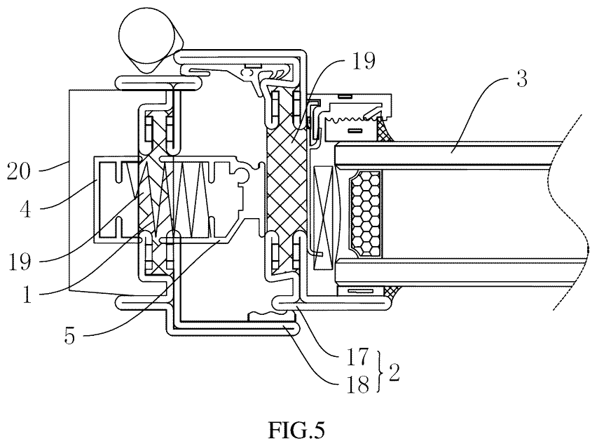

The difference between the second embodiment and the first embodiment is as follows. Referring to FIG. 5, the window frame 2 includes a main frame 17 and a mounting bracket 18 fixed on the main frame 17 by screws. The mounting bracket 18 of the present application is made of stainless steel to enhance the strength of the window frame 2. An acoustic seal block 19 is clamped and fixed on the sidewall of the mounting bracket 18, and extends along the height direction of the mounting bracket 18. An acoustic seal block 19 is also clamped and fixed on the sidewall of the main frame 17 in the height direction. The acoustic seal block 19 of the present application is made of rubber. The sealing performance of the mounting bracket 18 and the main frame 17 is improved by the acoustic seal block 19, so as to attenuate external noise transmission into the interior environment.

Referring to FIG. 5, a positioning groove is formed on the sidewall of the acoustic seal block 19, and the mounting housing 4 is inserted into and fixed in the positioning groove. The opening of the mounting housing 4 faces the main frame 17. Sliding grooves are formed on each acoustic seal block 19 which penetrate the sidewalls of each acoustic seal block 19. The border assembly 5 slides out from the main frame 17 through the sliding grooves, so as to position the screen mesh 1 to abut against the inner frame of the main frame 17 and shields the opening where the window sash 3 was located.

Referring to FIG. 5, aside of the mounting bracket 18 away from the main frame 17 is U-shaped. A protective housing 20 is clamped by the inner wall of the mounting bracket 18, the protective housing 20 is positioned on the side of the mounting bracket 18 away from the main frame 17. The protective housing 20 is configured to shield the acoustic seal block 19 from external light exposure on one hand, thereby decelerating UV-induced degradation, and on the other hand, to facilitate the disassembly of the mounting housing 4, and thus facilitating replacing and cleaning of the screen mesh 1.

In the second embodiment, the implementation principle of the concealed integrated screen assembly is the same as that of the first embodiment.

The above are all the exemplary embodiments of the present application, and the protection scope of the present application is not limited thereby. Therefore, all equivalent changes made in accordance with the structure, shape and principle of the present application shall be covered within the protection scope of the present application.

### LIST OF REFERENCE SIGNS

1 screen mesh
2 window frame
3 window sash
4 mounting housing
5 border assembly
6 first thermal barrier
7 magnetic block
8 snap-fit groove
9 restrictor bracket
10 waterproof sheet
11 second thermal barrier
12 pull tab
13 first stop groove
14 second stop groove
15 first retention groove
16 second retention groove
17 main frame
18 mounting bracket
19 acoustic seal block
20 protective housing

What is claimed is:

1. A concealed integrated screen assembly, comprising a screen mesh, a window frame and a window sash rotatably connected to a sidewall of the window frame, wherein the window frame is hollow, a mounting housing is fixed on an inner wall of the window frame, a first side of the screen mesh is fixedly connected with an inner wall of the mounting housing, a second side of the screen mesh is fixed with a border assembly slidably connected to the window frame, a locking member for fixing the border assembly is provided on the window frame at a portion away from the mounting housing, and the sidewall of the window frame is provided with a restrictor assembly configured for restricting a rotation of the window sash.

2. The concealed integrated screen assembly according to claim 1, wherein the inner wall of the window frame is fixed with a first thermal barrier, and the first thermal barrier is located between the window sash and a wall.

3. The concealed integrated screen assembly according to claim 1, wherein the locking member comprises a magnetic block fixed on the inner wall of the window frame, and the portion of the window frame away from the mounting housing is made of a material magnetically attractable to the magnetic block.

4. The concealed integrated screen assembly according to claim 3, wherein a snap-fit groove is formed on the sidewall of the window frame, a sidewall of the window sash is configured with a mounting keyway, the restrictor assembly comprises a restrictor bracket detachably fixed on the sidewall of the window sash, an end of the restrictor bracket away from the snap-fit groove is fixedly hooked in the mounting keyway, the restrictor bracket is located at a position on the window sash away from a pivot axis of the window sash, and the restrictor bracket is snap-fitted into the snap-fit groove.

5. The concealed integrated screen assembly according to claim 4, wherein edges of the restrictor bracket are configured with rounded corners, and an opening of the snap-fit groove features an arc transition.

6. The concealed integrated screen assembly according to claim 1, wherein a waterproof sheet is fixed on a sidewall of the window sash, and the waterproof sheet is angled to the window frame.

7. The concealed integrated screen assembly according to claim 2, wherein the inner wall of the window frame is detachably connected with a second thermal barrier, and the second thermal barrier is located between the first thermal barrier and the window sash.

8. The concealed integrated screen assembly according to claim 1, wherein a side of the border assembly away from the screen mesh is fixed with a pull tab, and the pull tab is angled to the screen mesh.

9. The concealed integrated screen assembly according to claim 1, wherein the window frame comprises a main frame and a mounting bracket fixed on the main frame, an acoustic seal block is fixed on a sidewall of the mounting bracket, the mounting housing is fixedly connected with the acoustic seal block, the border assembly is slidable out from the main frame, a protective housing is fixed on the sidewall of the mounting bracket, and the acoustic seal block is located inside the protective housing.
